(19) United States
(12) Patent Application Publication
(10) Pub. No.: US 2011/0287251 A1
(43) Pub. Date: Nov. 24, 2011

(54) NANOPARTICLE-MODIFIED FLUOROPOLYMER COATINGS

(75) Inventors: Lawrence D. Leech, West Chester, PA (US); Daniel C. Chung, Princeton, NJ (US)

(73) Assignee: WHITFORD CORPORATION, Elverson, PA (US)

(21) Appl. No.: 13/146,352

(22) PCT Filed: Feb. 10, 2010
(86) PCT No.: PCT/US10/23721

§ 371 Date: Jul. 26, 2011

Related U.S. Application Data
(60) Provisional application No. 61/152,295, filed on Feb. 13, 2009.

(51) Int. Cl. B32B 5/16; C08K 3/36

(52) U.S. Cl. 428/327; 524/493

(57) ABSTRACT

A fluoropolymer coating that includes nanoparticles for providing the coating with improved release characteristics together with improved abrasion resistance. In one embodiment, the nanoparticles are silica particles that may be incorporated into the coating by adding colloidal silica to the liquid coating formulation that is applied to a substrate, typically over a primer, and then cured. After the coating is cured, the coating demonstrates enhanced release characteristics together with improved abrasion resistance. It has been unexpectedly observed that a combination of desired release characteristics and improved abrasion resistance is found when the average particle size of the nanoparticles is between 30 and 120 nm, with the abrasion resistance generally increasing with increasing particle size.

### BACKGROUND OF THE INVENTION

1. Field of the Invention

The present invention relates to fluoropolymer coatings of the type used in cookware and/or other applications in which a non-stick and/or abrasion resistant surface is desired. In particular, the present invention relates to a fluoropolymer topcoat having improved non-stick or release characteristics, together with improved abrasion resistance, and articles coated therewith.

2. Description of the Related Art

The present invention relates to non-stick coating systems which are applied in single or multiple coats to the surface of a substrate to provide a coated substrate having a non-stick coating to which extraneous materials will not adhere. In a multiple layer coating system, the non-stick coating generally includes a primer and a topcoat, and optionally, a midcoat. More particularly, the present invention relates to a coating composition that provides excellent release and/or abrasion resistance properties.

The use of non-stick coating systems which are applied to a substrate in multiple layers has been known for many years. The primers for such systems typically contain a heat resistant organic binder resin and one or more fluoropolymer resins, along with various opaque pigments and fillers. The midcoats contain mainly fluoropolymers with some amounts of opaque pigments, fillers and coalescing aids, while the topcoats are almost entirely composed of fluoropolymers. In such systems, the binder resin of the primer adheres to the substrate, while the fluoropolymer adheres to subsequent midcoat and/or topcoat layers. The binder and fluoropolymer of the primer are attached to one another via an essentially mechanical bond resulting from the mixing of the two components, followed by the curing of the primer after application to a substrate.

A relatively more recent direction in the development of primers for such coatings is the inclusion of hard fillers to increase abrasion resistance. The use of such fillers in amounts up to 35% by weight of the solids content of the primer is known.

Similar approaches to the reinforcement of topcoats for abrasion resistance are ongoing. In the past, improved abrasion resistance in topcoats has been accomplished using a careful selection of pigment and filler, in conjunction with the proper selection of fluoropolymers used in the topcoat composition. Also, indirect reinforcement of topcoats has been achieved using large ceramic or metal particles in the primers, or large ceramic or metal particles that are directly applied to the substrate via plasma and/or arc spraying, which particles extend into the topcoats to improve abrasion resistance. Typically, these large ceramic or metal particles range in size from 5 to 75 microns (μm), for example.

Thus, it is known to improve the abrasion resistance of topcoats by the use of large ceramic particles, i.e., by “macro reinforcement”, either in the primer or on the substrate. However, in certain applications this technology may not be acceptable. For example, some applications require coatings that are very smooth and yet need to be abrasion resistant. In some applications, the applied coatings are machined and polished to reduce the coating surface roughness. Macro-reinforcement of primers may be unacceptable in these applications due to resulting coating roughness and concerns about the final machining and polishing operations. Yet, improved durability of the coatings remains desirable.

One disadvantage associated with the inclusion of hard fillers in coating systems, particularly in topcoats, is that the fillers tend to displace at least some of the fluoropolymer at the surface of the coating, which tends to negatively affect the release characteristics of the coating. In this manner, fillers have not typically been used in coatings where good release is desired.

Further improvements in the abrasion resistance and release characteristics of coatings, such as topcoats, are desired. Therefore, what is needed is a non-stick coating system that is an improvement over the foregoing.

### SUMMARY OF THE INVENTION

The present invention provides a fluoropolymer coating that includes nanoparticles for providing the coating with improved release characteristics together with improved abrasion resistance. In one embodiment, the nanoparticles are silica particles that may be incorporated into the coating by adding colloidal silica to the liquid coating formulation that is applied to a substrate, typically over a primer, and then cured. After the coating is cured, the coating demonstrates enhanced release characteristics together with improved abrasion resistance. It has been unexpectedly observed that a combination of desired release characteristics and improved abrasion resistance is found when the average particle size of the nanoparticles is between 30 and 120 nm, with the abrasion resistance generally increasing with increasing particle size.

In one form thereof, the present invention provides a fluoropolymer coating composition in liquid dispersion form, including at least one fluoropolymer; silica nanoparticles having an average particle size between 30 nm and 120 nm; and the balance water and optional additives.

The average particle size of the silica nanoparticles may be between 60 nm and 110 nm, or may be between 90 nm and 110 nm. The composition may include between 1.0 wt. % and 10 wt. % of the nanoparticles, or may include between 1.0 wt. % and 3.0 wt. % of the nanoparticles. The silica nanoparticles may be colloidal silica nanoparticles. The fluoropolymer may be selected from one or more of the group consisting of polytetrafluoroethylene, co-polymers of tetrafluoroethlyene and ethylene, co-polymers of tetrafluoroethlyene and perfluoro(alkyl vinyl ethers), co-polymers of tetrafluoroethlyene and perfluoro(ethyl vinyl ether), co-polymers of tetrafluoroethylene and perfluoro(propyl vinyl ether), co-polymers of tetrafluoroethlyene and perfluoro(methyl vinyl ether), co-polymers of tetrafluoroethylene and hexafluoropropylene, co-polymers of tetrafluoroethylene and perfluoropropylvinylether, co-polymers of tetrafluoroethylene and perfluoromethylvinylether, co-polymers of tetrafluoroethylene and polyvinylidene fluoride, and co-polymers of tetrafluoroethylene, hexafluoropropylene, and vinylidene difluoride. The composition may include polytetrafluoroethylene present in an amount between 33 and 45 wt. %; and a second fluoropolymer present in an amount between 0.5 and 6 wt. %.

In another form thereof, the present invention provides a coated article, including a substrate; a primer coated onto the substrate; and a topcoat coated onto said primer, the topcoat including at least one fluoropolymer; and silica nanoparticles having an average particle size between 30 nm and 120 nm.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a schematic representation of a test apparatus of the type used in the abrasion resistance evaluation of Example 2 herein.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

The present invention provides a fluoropolymer coating that includes nanoparticles for providing the coating with improved release characteristics together with improved abrasion resistance. In one embodiment, the nanoparticles are silica particles that may be incorporated into the coating by adding colloidal silica to the liquid coating formulation that is applied to a substrate, typically over a primer, and then cured. After the coating is cured, the coating demonstrates enhanced release characteristics together with improved abrasion resistance. It has been unexpectedly observed that a combination of desired release characteristics and improved abrasion resistance is found when the average particle size of the nanoparticles is between 30 and 120 nm, with the abrasion resistance generally increasing with increasing particle size.

In one embodiment, the present coating compositions are applied over an underlying coating, or undercoat. The undercoat may be a basecoat, which is the coating that is applied directly to an underlying substrate (referred to herein as a primer), optionally together with one or more midcoats. In these embodiments, the present coating may be referred to herein as either an “overcoat” or a “topcoat” and these terms are generally interchangeable, though the term “overcoat” is inclusive of a coating onto which another coating may be applied. In other embodiments, the present compositions may be applied directly to a substrate to form a coating in direct contact with the substrate whereby the coating is not applied over any undercoats. In further embodiments, the present coating system may itself also be an undercoat.

The relative amounts of the chemical components disclosed herein are typically referred to as a weight percent of a fluoropolymer coating composition in “wet” or liquid dispersion form, i.e., the fluoropolymer coating as aqueous dispersion or as an organic solvent-borne composition. After the coating is applied to a substrate, the coating is cured to drive off water and volatile components. When the coating is a topcoat, the coating will typically be applied over a primer coating.

As used herein, the term “nanoparticle” refers to a particle having a maximum dimension that is up to 180 nm. Suitable nanoparticles for use with the present invention may have an average particle size, or may encompass particles within a size distribution range, between as little as 5, 8, or 10 nm and as great as 120, 150, or 180 nm, for example. In another embodiment, the nanoparticles are equal to or greater than 30 nm in average size and may have an average particle size, or may encompass particles within a size distribution range, between as little as 30, 40, or 60 nm and as great as 70, 90 or 120 nm or possibly as great as 150, 160, or 180 nm, for example. In one embodiment, the average particle size of the nanoparticles may be as little as 30, 40, or 60 nm, or as great as 75, 90, 100, 110, or 120 nm, or within any range delimited by the foregoing values and/or by the values in the Examples herein.

The size distribution, as well as average size, of the particles is determined by a laser diffraction/scattering method using an optical analyzer such as, for example, a Model LA-950 laser diffraction/scattering particle size distribution analyzer, available from Horiba, Ltd. of Japan. This method is widely used, and is also referred to in the art as Low Angle Laser Light Scattering (“LALLS”). Laser diffraction/scattering particle size analysis is based on the observation that particles passing through a laser beam scatter light at an angle that is inversely proportional to their size. As particle size decreases, the observed scattering angle increases logarithmically. Scattering intensity is also dependent on particle size, diminishing with particle volume. Large particles therefore scatter light at narrow angles with high intensity whereas small particles scatter at wider angles but with low intensity.

Suitable nanoparticles include inorganic oxides, carbides, nitrides, and borides of: aluminum, silicon, titanium, zirconium, cerium, zinc, tungsten, tantalum, boron, antimony, nickel, and iron; metal oxides including indium tin oxide, barium titanate, and yttria stabilized zirconium oxide; core shell particles including titanium dioxide over silicon dioxide, aluminum oxide over silicon dioxide, and silver over silicon dioxide; and metals including silver and nickel. Particularly suitable nanoparticles include silica (silicon dioxide, SiO₂), titania (titanium dioxide, TiO₂), and alumina (aluminum oxide, Al₂O₃), for example.

Silica nanoparticles may be available in the form of colloidal silica, which are typically in the form of suspensions of fine amorphous, nonporous, spherical silica particles in a liquid phase. Colloidal silica may include silica particles of the above-described average particle size, and the colloidal silica may have a solids content as little as 10, 15, or 20 wt. %, or as great as 35, 40, or 45 wt. %, for example. Colloidal silicas may also include stabilizing agents, such as sodium or ammonia ions, to maintain the particles in their colloidal state and prevent sedimentation.

The nanoparticles, in the form of colloidal silica, for example, may be added in amounts from as little 0.5 wt. %, 1.0 wt. %, or 1.5 wt. % to as great as 3.0 wt. %, 5.0 wt. %, 7.5 wt. %, or 10 wt. % solids of the fluoropolymer coating composition, for example, based on the “wet” weight of the coating in liquid dispersion form. In a more particular embodiment, the nanoparticles may be added in amounts from as little as 1.0 wt. %, 1.25 wt. %, or 1.5 wt. %, to as great as 2.5 wt. %, 2.75 wt. %, or 3 wt. % solids of the fluoropolymer coating composition, based on the “wet” weight of the coating in liquid dispersion form.

Suitable fluoropolymers for use in the present coatings include one or more fluoropolymers, including polytetrafluoroethylene (PTFE), co-polymers of tetrafluoroethlyene and ethylene (ETFE), co-polymers of tetrafluoroethlyene and perfluoro(alkyl vinyl ethers) (PAVE), co-polymers of tetrafluoroethlyene and perfluoro(ethyl vinyl ether) (PEVE), co-polymers of tetrafluoroethylene and perfluoro(propyl vinyl ether) (PPVE), co-polymers of tetrafluoroethlyene and perfluoro(methyl vinyl ether) (PMVE), co-polymers of tetrafluoroethylene and hexafluoropropylene (FEP), co-polymers of tetrafluoroethylene and perfluoropropylvinylether (PFA), co-polymers of tetrafluoroethylene and perfluoromethylvinylether (MFA) and polyvinylidene fluoride (PVDF), and co-polymers of tetrafluoroethylene, hexafluoropropylene, and vinylidene difluoride (THV), and other perfluorinated polymers. Fluoroelastomers based on PTFE and THV may also be used.

In some embodiments, the PTFE may include a small amount of modifying co-monomer, in which case the PTFE is a co-polymer known in the art as “modified PTFE” or “trace modified PTFE”. Examples of the modifying co-monomer include perfluoropropylvinylether (PPVE), other modifiers, such as hexafluoropropylene (HFP), chlorotrifluoroethylene (CTFE), perfluorobutylethylene (PFBE), or other perfluoroalkylvinylethers, such as perfluoromethylvinylether (PMVE) or perfluoroethylvinylether (PEVE). The modifying co-monomer will typically be present in an amount less than 1% by weight, for example, based on the weight of the PTFE.

When PTFE is used as the primary fluoropolymer of the topcoat, the PTFE will typically have a number average molecular weight (Mn) of at least 1×10⁶ or at least 2×10⁶, and may be as high as 5×10⁶.

In one embodiment, the topcoat includes a majority amount of a first fluoropolymer, such as PTFE, with an additional or second fluoropolymer such as PFA or any of those listed above. The amount of the first flouropolymer, such as PTFE, may be as little as 30 wt. %, 33 wt. %, or 36 wt. %, or as great as 39 wt. %, 42 wt. %, or 45 wt. % solids, based on the “wet” weight of the coating in liquid dispersion form. The amount of the additional or second fluoropolymer may be as little as 0.5 wt. %, 1.0 wt. %, or 1.5 wt. %, or as great as 2 wt. %, 4 wt. %, or 6 wt. % solids, based on the “wet” weight of the coating in liquid dispersion form.

If the coating is a primer, for example, the coating may also include one or more polymer binder resins for adhering to the substrate. Suitable polymer binder resins include ethylene-vinyl acetate (EVA), polyurethane dispersions (PUD), acrylic resins, polyvinyl alcohol (PVOH) resins, polyvinylidine difluoride (PVDF) resins, polyvinyldichloride (PVDC) resins, polyetheretherketone (PEEK) resins, polyamideimide (PAI) resins, polyimide (PI) resins, polyphenylene sulfide (PPS), polyether sulfone (PES), polyarylsulfone (PAS) resins, polyaryllene-etherketone, polyetherimide, and poly(1,4(2,6-dimethylephenyl) oxide) or polyphenylene oxide (PPO), epoxy resins, polyester resins, polyvinyl chloride (PVC) resins, melamine-formaldehyde resins, and other suitable polymeric resins that can either be dispersed or dissolved in water.

The topcoats may also include optional additives, such as ionic or nonionic surfactants, pigments, coalescing aids, catalysts, and solvents.

As set forth in Example 1 below, it has been found that the addition of colloidal silica particles to fluoropolymer topcoats exhibited unexpected and interesting effects. In particular, while these investigations uncovered improved abrasion resistance in the modified topcoats, it was also revealed that the same topcoats with nanoparticles of smaller size lost release characteristics as measured per the dry egg release test described in detail below. In particular, non-modified topcoats exhibited a release rating of at least 4 on a 1-5 rating scale with a rating of 5 the best, whereas the topcoats modified with nanoparticles of smaller size rated 1 on release.

When these topcoats were modified with the various particle size colloidal silica dispersions, similar effects were noted in the smaller particle size ranges. However, it was also unexpectedly noted that as colloidal silica particle size increased beyond 30 nm, the negative effects on release characteristics were reduced or eliminated. Further, these investigations revealed that when colloidal silica particle size exceeded 30 nm, improved release characteristics were achieved in addition to improved abrasion resistance as compared to unmodified controls.

### EXAMPLES

The following non-limiting Examples illustrate various features and characteristics of the present invention, which is not to be construed as limited thereto. Throughout the Examples and elsewhere herein, percentages are by weight unless otherwise indicated.

Materials and Methods.

The “dry egg release test” and the “reciprocating abrasion test” of Example 1 herein are described in detail below. The method of determining particle size distribution and average particle size is also described in detail below.

I. Dry Egg Release Test.

Scope. This procedure is used as a quick method of determining the ability of food to be released from a non-stick coating for cookware. When used with care, this test may be used as an on-line control test to measure the consistency of production. The test is somewhat subjective and dependent upon the equipment used and the technique of the tester.

Equipment and Materials.

(1) An electric stove burner rated 1500 watts or gas range burner.

(2) Contact pyrometer (thermocouple) capable of measuring over 260° C. (500° F.).

(3) Plastic, metal or coated metal spatula.

(4) Timer or watch with second hand.

(5) Cold, fresh, large size hen eggs.

(6) Tap water, mild dish detergent, paper towels.

Procedure.

(1) Wash coated utensil to be tested with tap water and mild detergent solution. Rinse several times in hot tap water and blot dry with a paper towel.

(2) Turn on electric or gas burner to a medium setting. Allow burner to come to temperature for 3-5 minutes.

(3) Place the utensil on the center of burner. Allow to heat while monitoring the temperature with the pyrometer. Allow the utensil to heat to 143° C.-154° C. (290° F.-310° F.). Alternately, if a pyrometer is not available, the temperature may be judged by sprinkling a few drops of water on the surface periodically as the utensil heats. The test temperature has been reached when the drops of water steam and “dance” immediately upon contact with the surface.

(4) Crack and gently place the contents of one cold, fresh egg in the centre of the utensil. Do not tip or swirl the utensil or cause the egg to run.

(5) Allow the egg to cook for two (2) minutes undisturbed. Monitor temperature of the pan as the egg cooks. Record the temperature of the utensil. The temperature on the utensil should rise to 193° C.-215° C. (380° F.-420° F.) at the end of two minutes. If the end point temperature is outside this range, adjust the burner control up or down as appropriate and repeat the test. (Note: The correct burner control setting may be determined in advance using a separate utensil of the same construction as the test utensil.)

(6) At the end of two minutes, lift egg with spatula. Free egg completely from the surface, noting the amount of effort required. Once the egg has been freed, remove the utensil from the burner and tilt. Note the ease or difficulty with which the egg slides in the bottom of the utensil.

(7) Return utensil to burner. Turn egg over and break yolk with spatula. Allow egg to cook another two (2) minutes. Repeat Step 6. In addition, make note of any staining and the amount of material adhering to the utensil.

Evaluation.

Record effort required to free egg from surface. Egg that lifts easily from surface with no sticking around edges indicates excellent release. Diminishing release down to complete sticking may be noted by amount of effort required to lift the egg.

A numerical and descriptive rating system is as follows:

| Numeric | Descriptive | Performance |
|---|---|---|
| 5 | Excellent | No sticking in centre or around edges of egg. |
| | | Slides easily. |
| 4 | Good | Slight sticking around edges. Slides easily. |
| 3 | Fair | Moderate sticking on edges; slight sticking in |
| | | centre. Slides only if steeply tilted and shaken. |
| 2 | Poor | Requires considerable effort to free egg, but |
| | | can be freed intact. Does not slide. |
| 1 | Very Poor | Egg cannot be freed from surface without |
| | | breaking up. |

If a control sample is available, record results as much better than, better than, equal, worse than or much worse than the control.

Comments/Precautions.

The results of this test are subjective and are best applied on a relative basis using a known standard as control. Repeatability will be good for the same tester and equipment. Repeatability will be improved with experienced testers using the same equipment. Results may vary if utensils of different materials of construction or size are compared. In every case, the burner control settings should be adjusted to provide the same heat up profile for best correlation of results.

II. Reciprocating Abrasion Test.

Scope. This test measures the resistance of coatings to abrasion by a reciprocating Scotch-Brite pad. The test subjects coating abrasion in a back and forth motion. The test is a measure of the useful life of coatings that have been subjected to scouring and other similar forms of damage caused by cleaning. TM 135C is specific to a test apparatus built by Whitford Corporation of West Chester, Pa. However, it is applicable to similar test methods such as the one described in British Standard 7069-1988.

Equipment and Materials.

(1) A test machine capable of holding a Scotch-Brite abrasive pad of a specific size to the surface to be tested with a fixed force and capable of moving the pad in a back and forth (reciprocating) motion over a distance to 10-15 cm (4 to 6 inches). The force and motion are applied by a free falling, weighted stylus. The machine must be equipped with a counter, preferably one that may be set to shut off after a given number of cycles.

(2) Scotch-Brite pads of required abrasiveness cut to required size. Scotch-Brite pads are made by 3M Company, Abrasive Systems Division, St Paul, Minn. 55144-1000. Pads come in grades with varying levels of abrasiveness as follows:

Lowest—7445, 7448, 6448, 7447, 6444, 7446, 7440, 5440—Highest

Scotch-Brite pads may be used at temperatures up to 150° C. (300° F.). Equivalent pads may be used.

(3) Hot plate to heat test specimens. (Optional)

(4) Detergent solution or oil for performing test in with a liquid. (Optional)

Procedure. Before beginning the test, the end point must be defined. Usually, the end point is defined when some amount of substrate has been exposed. However, the end point may be defined as a given number of strokes even if substrate is not exposed. The present inventors use a 10% exposure of substrate over the abraded area as the standard definition of end point. Other end points may be used.

Secure the part to be tested under the reciprocating pad. The part must be firmly fastened with bolts, clamps or tape. The part should be as flat as possible and long enough so that the pad does not run off an edge. Bumps in the surface will wear first, and overrunning an edge can tear the pad and cause premature scratching and a false result.

Cut a piece of Scotch Brite of required abrasiveness to the exact size of the “foot” of the stylus. The present inventors use Grade 7447 as standard, and the “foot” of the stylus on the test machine is 5 cm (2 inches) in diameter. Attach the pad to the bottom of the “foot.” The Scotch-Brite pad is fixed to the “foot” by means of a piece of “Velcro” glued to the bottom of the foot.

If the machine has an adjustable stroke length, set the required length. The present inventors use a 10 cm (4 inch) stroke length as standard. Lower the pad onto the surface of the piece to be tested. Make sure that the weight is completely free. The present inventors used a 1.5 Kg weight as standard, but this can be varied.

If the machine is equipped with a counter, set the counter to the required number of strokes. One stroke is a motion in one direction. If the machine does not have an automatic counter, the counter must be watched so that the machine can be turned off at the proper time. The machine is stopped at various intervals to change the abrasive pad. The abrasiveness of the pad changes (usually becomes less effective) as the pad fills with debris. The present inventors changed pads at intervals of 2,000 strokes. One thousand strokes is the preferred interval between pad changes.

Start the test machine. Allow to run until an end point is reached or until a required number of strokes are attained before changing the pad.

Inspect the test piece carefully at the beginning and end of each start up. As the end point is approached, the substrate will begin to show through the coating. When close to the end point, observe the test piece constantly. Stop the machine when the end point has been reached.

Evaluation. Record the following for the test machine:

1. Grade and size of Scotch-Brite pad.

2. Load on stylus

3. Number of strokes between pad changes.

4. Length of stroke.

5. Definition of end point.

6. Number of strokes to end point.

Duplicate tests provide greater reliability. Indicate if end point is a single result or the average of several results. Record the description of the coating, the film thickness, and the substrate and surface preparation.

If the test is conducted to a specific number of strokes, record the number of strokes. Record a description of the amount of wear, such as percent of substrate exposed, or number of strokes to first substrate exposure. Optionally, record the film thickness and/or weight before and after testing.

If the test is performed at elevated temperature, record the temperature of the test. If performed with a liquid, record the specifics of the liquid.

Comments/Precautions. Both sides of a Scotch-Brite pad may be used. Pads must be cut precisely to fit the “foot.” Ragged edges or rough spots on the pad will give false results. Test pieces must be flat and free from dirt or other particles. This test method is similar to the abrasion test described in BS 7069:1988, Appendix A1. When tested according to BS 7069, test pieces are immersed in 50 cm³ of a 5 g/liter solution of household dish washing detergent in water. The test runs for 250 cycles with pads changed every 50 cycles.

III. Particle Size.

Scope. A general procedure for the operation and verification of a laser scattering particle size distribution analyser for analysis of particle size of wet samples.

Equipment. Horiba Particle Size Analyser, Model LA-950 and the Miniflow cell LV-9502.

Procedure.

1. Turn the unit power on.

2. Wait at least one hour after turning the LA-950 power ON before performing measurements to ensure that all unit conditions are stable.

3. Boot up the computer.

4. Double click the LA-950 icon on the desktop.

5. Click “Yes” to match the application mode to the type of cell and start it.

6. Go onto measurement screen (third icon top left of screen).

7. Place the fill tube in a bottle of Deionised Water or alternative solvent as required depending on the sample to be measured.

8. Click on “Feed” to fill the Miniflow cell.

9. Click on “De-bubble” to release the circulation systems trapped air.

10. Click on “Circulation” Level 3 to start the circulation of the water/solvent. Note the optimum circulation speed will vary depending on the type of sample and dispersion medium. For example a heavy sample can sediment under slow circulation speed or air dissolved in a sample solution can become foam and bubbles become attached to the inside of the cell if the circulation becomes too fast.

11. Click on “Alignment”.

12. Go to “Set Conditions for Next Measurement” under the Conditions tab.

13. Fill in sample information, for example, Sample Name, Material, Source and Lot Number as required.

14. Select refractive index file for material to be analysed or if not available create a new refractive index file by clicking on create and entering refractive index details.

15. Check Form of Distribution that Auto is selected.

16. Check Distribution Base box that Volume is selected.

17. Click “Advanced”. Go to Calculation tab.

18. Check Algorithm Option that Standard Calculation is selected.

19. Check Density Distribution Graph that Standard is selected.

20. LD Wavelength=655.0 nm/LED Wavelength=405.0 nm.

21. Go to Measurement tab.

22. Transmittance (R) Upper 90% Lower 80%. Transmittance (B) Upper 90% Lower 70%. Feed Liquid Level. Check High. Number of times to rinse. Enter 2.

23. Data acquisition times (Sample).
LD 5000
LED 5000

24. Data acquisition times (Blank)
LD5000
LED5000

25. Click “OK”

26. Click on “Blank”

27. Add drops of sample to Miniflow cell using a pipette. Add sufficient sample to achieve proper T %.
a. 100 nm—below 95% on blue light source.
b. All others—below 95% on red light source.

28. Click on “Measurement”

29. When prompted enter a filename and ensure it is saved to an appropriate folder.

30. Take 3 measurements per sample.

31. Click on “Rinse” to Drain and Fill the Miniflow cell with water/solvent at least twice to clean the cell. If sample solution remains in the units circulation system for a long period of time, it may become impossible to clean the circulation system and the cell.

32. Exit the LA-950A software.

Evaluation. Record Mean (not Median) Particle size. Record Maximum Particle Size. The maximum particle size equals the highest channel size where no value appears in the distribution.

### Example 1

### Release and Abrasion Resistance of Nanoparticle-Modified Coatings

The base formulation of the topcoat used in this Example is set forth in Table 1 below. In Tables 1 and 2 below, “topcoat A” is the unmodified control, while “topcoat B” refers to topcoats modified with added colloidal silica.

TABLE 1
Topcoat A, wt. %.

| Ingredient | Wet | Dry |
|---|---|---|
| Colloidal silica (Table 2 below) | 0.00 | 0.00 |
| PTFE | 38.45 | 92.67 |
| PFA | 1.86 | 4.48 |
| Acrylic Polymer | 3.91 | 0.00 |
| Carbon Black | 0.58 | 1.40 |
| Nonionic surfactant | 3.77 | 0.00 |
| Oleic acid | 0.60 | 0.00 |
| Diethylene Glycol Monobutyl | 1.25 | 0.00 |
| Ether | | |
| Aromatic Hydrocarbon | 0.71 | 0.00 |
| Cerium Octoate | 0.60 | 1.45 |
| Water | 45.89 | 0.00 |
| Triethanolamine | 2.38 | 0.00 |
| Total | 100.00 | 100.00 |

2.0 wt. % colloidal silica was added to the above topcoat formulation using the different colloidal silica dispersions that are set forth in Table 2 below. Table 2 also sets forth the physical properties of the colloidal silica dispersions, as well as the results of the dry egg release and reciprocating abrasion tests described above.

The topcoats were applied to mildly-etched aluminum pans on which a smooth technology type primer, with no internal macro-reinforcement, had been previously applied and flashed for 2 minutes in an oven at 100° C. The topcoats were then applied over the primers and cured for 5 minutes at 430° C., based on the temperature of aluminum pans.

TABLE 2
Colloidal silica physical properties and test results of modified topcoats.

| | | | | Parts | | | |
|---|---|---|---|---|---|---|---|
| | | | | colloidal | | Dry Egg | |
| Colloidal | | | | silica | | Release | |
| Silica | Particle | | Colloidal | dispersion | Amount | test, 1-5 | Recip. |
| added to | size | Ave. | Silica | added to | of silica | scale | abrasion |
| Topcoat | distribution, | particle | Solids, | 92 parts | added, | with 5 | test, |
| B | nm | size, nm | wt. % | Topcoat A | wt. % | best | cycles/μm |
| (Topcoat A) | N/A | N/A | N/A | 0 | N/A | 4/5 | 109 |
| (control) | | | | | | | |
| Colloidal | 15-20 | 17.5 | 40 | 2.0 | 2.0 | 1 | 160 |
| silica 1 | | | | | | | |
| Colloidal | 3-8 | 5.5 | 16-19 | 4.7 | 2.0 | 1 | 162 |
| silica 2 | | | | | | | |
| Colloidal | 18-30 | 24 | 30-32 | 2.6 | 2.0 | 2/3 | 171 |
| silica 3 | | | | | | | |
| Colloidal | 18-30 | 24 | 30-32 | 2.6 | 2.0 | 2/3 | 166 |
| silica 4 | | | | | | | |
| Colloidal | 30-50 | 40 | 39-41.5 | 2.0 | 2.0 | 4/5 | 213 |
| silica 5 | | | | | | | |
| Colloidal | 60-90 | 75 | 40-42 | 2.0 | 2.0 | 5 | 230 |
| silica 6 | | | | | | | |
| Colloidal | 90-120 | 105 | 40-42 | 2.0 | 2.0 | 5 | 259 |
| silica 7 | | | | | | | |

In the column labeled “particle size distribution” in Table 2 above, 10% of the particles have a maximum dimension falling below the low end of the range, while 10% of the particles have a maximum dimension falling above the upper end of the range, such that 80% of the particles have a maximum dimension falling within the range.

These results indicate that the largest particle size colloidal silica dispersions evaluated (60-90 nm distribution and 75 nm average for colloidal silica 6 and 90-120 nm distribution and 105 average for colloidal silica 7) achieved the most favorable results. Compared to the control topcoat, abrasion resistance was improved in the modified topcoats for all colloidal dispersions evaluated. The most pronounced improvements regarding the reciprocating abrasion test were noted using the largest particle size colloidal silica dispersions.

Perhaps a more pronounced effect based on colloidal silica dispersion particle size was noted regarding the dry egg release test. The topcoats modified with the largest particle size colloidal silica dispersions actually exhibited release characteristics better than the control topcoat in the dry egg release test. These improvements in release were confirmed in contact angle measurements from photos taken with a Krüss Drop Shape Analysis System Model 10 MK2 showing the interaction of a droplet of water with the topcoat film. This device measures the surface energy of a coating by measuring contact angle and interaction of a droplet of water with the evaluated film. The higher the contact angle, the higher the surface energy of the coating. As the surface energy of a coating increases, release improves. The contact angle of the control topcoat was ˜126°, while the contact angle of the same coating modified with colloidal silica 7 per Table 2 above was 131°, thus indicating improved release characteristics in the modified topcoat.

### Example 2

### Abrasion Resistance of Nanoparticle-Modified FEP Coatings

In this Example, the abrasion resistance of several modified FEP coatings was investigated, in which existing FEP dispersions were modified with fluoropolymer and nanoparticles as set forth below in Table 3 below:

TABLE 3
Modified FEP dispersion formulations.

| | FEP Dispersion | | |
|---|---|---|---|
| Coating # | (Table 4 below) | Fluoropolymer | Nanoparticle |
| 1 | 100 parts | 7 parts 60% PTFE | none (control) |
| | | dispersion | |
| 2 | 100 parts | 7 parts 60% PTFE | 4 parts colloidal |
| | | dispersion | silica, 20 wt. %, |
| | | | aqueous |
| | | | dispersion, |
| | | | elongated particles |
| | | | of 5 nm × 100 nm |
| 3 | 100 parts | 7 parts 60% PTFE | 6 parts colloidal |
| | | dispersion | silica, 20 wt. %, |
| | | | aqueous |
| | | | dispersion, |
| | | | elongated particles |
| | | | of 5 nm × 100 nm |
| 4 | 100 parts | 7 parts 60% PTFE | 4 parts colloidal |
| | | dispersion | silica, 30 wt. %, |
| | | | aqueous |
| | | | dispersion, 50 nm |
| | | | particles |

The formulation of the FEP dispersion in Table 3 above is set forth in Table 4 below:

TABLE 4
FEP Dispersion.

| Ingredient | wt. % |
|---|---|
| Deionized water | 20.850 |
| Triethanolamine | 1.050 |
| Silicone surfactant | 0.750 |
| Aromatic Hydrocarbon | 1.000 |
| Acrylic thickener | 0.800 |
| FEP dispersion | 73.300 |
| Fungicide | 0.250 |
| Polyethylene Glycol | 2.000 |

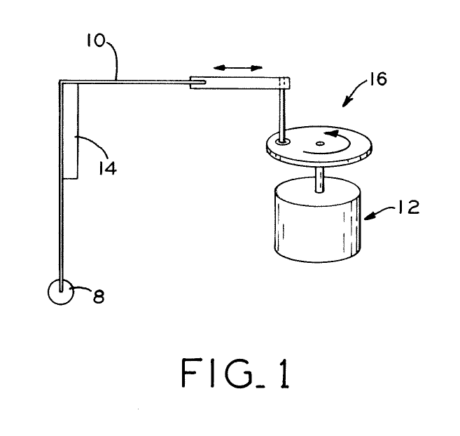

Referring to FIG. 1, in order to measure abrasion resistance, a polyimide sheet measuring 8×11 inches was coated on one side, and the coating was cured for 5 minutes at 400° C. (750° F.). The sheet was then cut into ribbons 10 each measuring about 1 inch wide by 11 inch long. A reciprocal abrasion tester 12 was used to pull the coated polyimide ribbon 10 over stainless steel panel 14. As shown in FIG. 1, the ribbon 10 is attached a one end to a suitable reciprocating mechanism 16 such as an eccentric or cam drive, and a 0.5 kg weight 18 is attached to its opposite end. The ribbon 10 is bent over the edge of stainless steel panel 14 at a 90° angle. After 2000 cycles, the thickness of the film was measured. The difference of the thickness between the abraded area of the film and the non-abraded area is the measurement of the abrasion resistance. The test results are set forth below in Table 5 as follows:

TABLE 5
Measured film reduction.

| Coating # | Measured film reduction |
|---|---|
| 1 | 0.062 mils |
| 2 | 0.078 mils |
| 3 | 0.028 mils |
| 4 | 0.014 mils |

As indicted below, coating 4 demonstrated the least film reduction and therefore the greatest abrasion resistance.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fluoropolymer coating composition in liquid dispersion form, comprising:
at least one fluoropolymer;
silica nanoparticles having an average particle size between 30 nm and 120 nm; and
the balance water and optional additives.

2. The fluoropolymer coating composition of claim 1, wherein said average particle size of said silica nanoparticles is between 60 nm and 110 nm.

3. The fluoropolymer coating composition of claim 1, wherein said average particle size of said silica nanoparticles is between 90 nm and 110 nm.

4. The fluoropolymer coating composition of claim 1, wherein said composition includes between 1.0 wt. % and 10 wt. % of said nanoparticles.

5. The fluoropolymer coating composition of claim 1, wherein said composition includes between 1.0 wt. % and 3.0 wt. % of said nanoparticles.

6. The fluoropolymer coating composition of claim 1, wherein said silica nanoparticles are colloidal silica nanoparticles.

7. The fluoropoylmer coating composition of claim 1, wherein said fluoropolymer is selected from one or more of the group consisting of polytetrafluoroethylene, co-polymers of tetrafluoroethlyene and ethylene, co-polymers of tetrafluoroethlyene and perfluoro(alkyl vinyl ethers), co-polymers of tetrafluoroethlyene and perfluoro(ethyl vinyl ether), co-polymers of tetrafluoroethylene and perfluoro(propyl vinyl ether), co-polymers of tetrafluoroethlyene and perfluoro(methyl vinyl ether), co-polymers of tetrafluoroethylene and hexafluoropropylene, co-polymers of tetrafluoroethylene and perfluoropropylvinylether, co-polymers of tetrafluoroethylene and perfluoromethylvinylether, co-polymers of tetrafluoroethylene and polyvinylidene fluoride, and co-polymers of tetrafluoroethylene, hexafluoropropylene, and vinylidene difluoride.

8. The fluoropolymer coating composition of claim 1, comprising:
polytetrafluoroethylene present in an amount between 33 and 45 wt. %; and
a second fluoropolymer present in an amount between 0.5 and 6 wt. %.

9. A coated article, including a substrate, a primer coated onto said substrate, and the topcoat of claim 1 coated onto said primer.
